(19) United States
(12) Patent Application Publication
(10) Pub. No.: US 2018/0314107 A1
(43) Pub. Date: Nov. 1, 2018

(54) COLOR CONVERSION PANEL AND DISPLAY DEVICE INCLUDING THE SAME

(71) Applicant: Samsung Display Co., Ltd., Yongin-si (KR)

(72) Inventors: Joon Yong PARK, Gunpo-si (KR); Gyung Min BAEK, Yongin-si (KR); Hyun Eok SHIN, Gwacheon-si (KR); Sang Won SHIN, Yongin-si (KR); Chan Woo YANG, Siheung-si (KR); Ju Hyun LEE, Seongnam-si (KR)

(21) Appl. No.: 15/847,633

(22) Filed: Dec. 19, 2017

(30) Foreign Application Priority Data
Apr. 26, 2017 (KR) 10-2017-0053690

(51) Int. Cl. G02F 1/1335; G02F 1/1368

(52) U.S. Cl. CPC G02F 1/133514; G02F 1/133553; G02F 1/133512; G02F 1/1368

(57) ABSTRACT

An exemplary embodiment provides a color conversion display panel including: a substrate including a display area and a light-blocking area; a metal oxide layer disposed on the substrate to overlap the display area and the light-blocking area; a reflective metal layer disposed on the metal oxide layer to overlap the light-blocking area; a color conversion layer disposed on the metal oxide layer which overlaps the display area to include semiconductor nanocrystals; and a transmission layer disposed on the metal oxide layer which overlaps the display area.

### CROSS-REFERENCE TO RELATED APPLICATION

This application claims priority to and the benefit of Korean Patent Application No. 10-2017-0053690 filed in the Korean Intellectual Property Office on Apr. 26, 2017, the entire contents of which are incorporated herein by reference.

### BACKGROUND

### (a) Field

The present disclosure relates to a color conversion display panel and a display device including the same.

### (b) Description of the Related Art

A liquid crystal display used as a display device may include two field generating electrodes, a liquid crystal layer, a color filter, and a polarization layer. Light emitted from a light source passes through the liquid crystal layer, the color filter, and the polarization layer to reach a viewer. In this case, optical loss may be generated in the polarization layer, the color filter, and the like. The optical loss may be generated not only in the liquid crystal display, but also in a display device such as an organic light emitting diode display.

A display device including a color conversion display panel using semiconductor nanocrystals such as quantum dots has been proposed in order to reduce a loss of light generated from a polarizing layer or the like and to realize a display device having a high color reproduction rate.

The above information disclosed in this Background section is only for enhancement of understanding of the background and therefore it may contain information that does not form the prior art that is already known in this country to a person of ordinary skill in the art.

### SUMMARY

Exemplary embodiments have been made in an effort to provide a display device capable of increasing light efficiency in the display device while reducing external light reflection.

An exemplary embodiment provides a color conversion display panel including: a substrate including a display area and a light-blocking area; a metal oxide layer disposed on the substrate to overlap the display area and the light-blocking area; a reflective metal layer disposed on the metal oxide layer to overlap the light-blocking area; a color conversion layer disposed on the metal oxide layer which overlaps the display area to include semiconductor nanocrystals; and a transmission layer disposed on the metal oxide layer which overlaps the display area.

The metal oxide layer may include: a first metal oxide layer overlapping the light-blocking area; and a second metal oxide layer overlapping the display area, and a thickness of the first metal oxide layer may be different from a thickness of the second metal oxide layer.

The thickness of the first metal oxide layer may be greater than the thickness of the second metal oxide layer.

The thickness of the first metal oxide layer may be in a range of about 300 to 700 Å, and the thickness of the second metal oxide layer may be in a range of about 20 to 50 Å. The reflective metal layer may overlap the first metal oxide layer.

The metal oxide layer may include an oxide including at least one of molybdenum (Mo) and tantalum (Ta).

The metal oxide layer may further include at least one of tantalum (Ta), titanium (Ti), tungsten (W), niobium (Nb), and the like. The reflective metal layer may include aluminum (Al). The reflective metal layer may further include at least one of nickel (Ni), lanthanum (La), neodymium (Nd).

The metal oxide layer may contact a side surface of the reflective metal layer.

The color conversion display panel may further include a capping layer disposed between the reflective metal layer and the color conversion layer, and between the reflective metal layer and the transmission layer.

The second metal oxide layer may be disposed between the capping layer and the color conversion layer, and between the capping layer and the transmission layer.

An exemplary embodiment provides a display device including: a thin film transistor array panel; and a color conversion display panel facing the thin film transistor array panel, wherein the color conversion display panel includes: a substrate including a display area and a light-blocking area; a metal oxide layer disposed on the substrate to overlap the display area and the light-blocking area; a reflective metal layer disposed on the metal oxide layer to overlap the light-blocking area; a color conversion layer disposed on the metal oxide layer which overlaps the display area to include semiconductor nanocrystals; and a transmission layer disposed on the metal oxide layer which overlaps the display area.

An exemplary embodiment provides a display device including: a thin film transistor array panel; and a color conversion display panel facing the thin film transistor array panel, wherein the color conversion display panel includes: a substrate including a display area and a light-blocking area; a metal oxide layer overlapping the display area and the light-blocking area; a reflective metal layer overlapping the light-blocking area; a color conversion layer disposed on the metal oxide layer which overlaps the display area to include semiconductor nanocrystals; and a transmission layer disposed on the metal oxide layer which overlaps the display area.

Exemplary embodiments improve light efficiency by increasing reflectivity in the display device while reducing external light reflection. Accordingly, the display device including the color conversion display panel may realize excellent contrast ratio and color reproducibility.

### BRIEF DESCRIPTION OF THE DRAWINGS

FIG. 1 is a top plan view illustrating a plurality of pixels according to an exemplary embodiment.

FIG. 2 is a cross-sectional view taken along a line II-II′ of FIG. 1.

FIG. 3 is a cross-sectional view according to a modification of FIG. 2.

FIG. 4 and FIG. 5 are respectively cross-sectional views of a process of manufacturing a color conversion display panel of FIG. 3.

FIG. 6 is a cross-sectional view according to a modification of FIG. 2.

### DETAILED DESCRIPTION OF THE EMBODIMENTS

The inventive concept will be described more fully hereinafter with reference to the accompanying drawings, in which exemplary embodiments are shown. As those skilled in the art would realize, the described embodiments may be modified in various different ways, all without departing from the spirit or scope of the inventive concept.

To clearly describe the inventive concept, parts that are irrelevant to the description are omitted, and like numerals refer to like or similar constituent elements throughout the specification.

Further, since sizes and thicknesses of constituent members shown in the accompanying drawings are arbitrarily given for better understanding and ease of description, the embodiments are not limited to the illustrated sizes and thicknesses. In the drawings, the thickness of layers, films, panels, regions, etc., are exaggerated for clarity. In the drawings, for better understanding and ease of description, the thicknesses of some layers and areas are exaggerated.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, the word “over” or “on” means positioning on or above the object portion, but does not essentially mean positioning on the upper side of the object portion based on a gravity direction.

In addition, unless explicitly described to the contrary, the word “comprise” and variations such as “comprises” or “comprising” will be understood to imply the inclusion of stated elements but not the exclusion of any other elements.

Further, in the specification, the phrase “in a plan view” means when an object portion is viewed from above, and the phrase “in a cross-section” means when a cross-section taken by vertically cutting an object portion is viewed from the side.

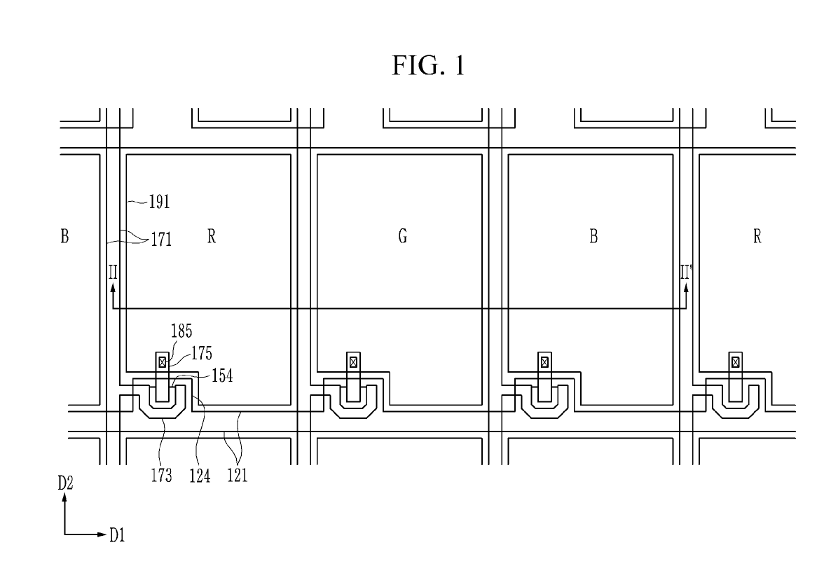

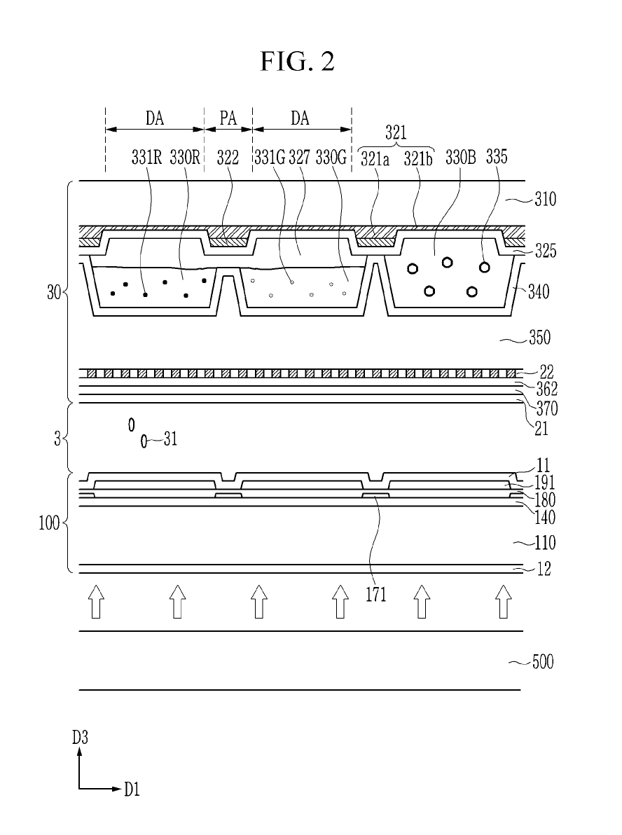

Hereinafter, a display device according to an exemplary embodiment will be described with reference to FIG. 1 and FIG. 2. FIG. 1 is a top plan view illustrating a plurality of pixels according to an exemplary embodiment, and FIG. 2 is a cross-sectional view taken along a line II-II′ of FIG. 1.

Referring to FIG. 1 and FIG. 2, the display device according to the present exemplary embodiment includes a light unit 500, a thin film transistor array panel 100, a color conversion display panel 30 separately disposed to face the thin film transistor array panel 100, and a liquid crystal layer 3 disposed between the thin film transistor array panel 100 and the color conversion display panel 30.

The light unit 500 may include a light source disposed in a rear surface of the thin film transistor array panel 100 to generate light, and a light guide (not illustrated) disposed to receive light and to guide the received light toward the thin film transistor array panel 100 and the color conversion display panel 30.

The light unit 500 may include any light source for emitting blue light, e.g., a light emitting diode (LED). The light source may be an edge type disposed on at least one lateral surface of the light guide (not illustrated), or a direct type in which the light source of the light unit 500 is disposed directly under the light guide (not shown), but the embodiments are not limited thereto. A light unit 500 including a white light source or an ultraviolet ray light source may be modified to be used instead of the aforementioned light unit 500 including the blue light source. However, the display device using the light unit 500 including the blue light source will be described hereinafter.

The thin film transistor array panel 100 is disposed between the liquid crystal layer 3 and the light unit 500.

The thin film transistor array panel 100 includes a first polarization layer 12 disposed between a first substrate 110 and the light unit 500. The first polarization layer 12 serves to polarize light introduced from the light unit 500.

The first polarization layer 12 may include at least one of an applied polarization layer, a coated polarization layer, and a wire grid polarizer. The first polarization layer 12 may be disposed on one side of the first substrate 110 in various forms such as a film form, a coating form, an attachment form, a printing form, and the like, but it is not limited thereto.

A plurality of pixels are arranged in a matrix shape on the first substrate 110.

The thin film transistor array panel 100 may include a gate line 121 extended between the first substrate 110 and the liquid crystal layer 3 in a first direction D1 and including a gate electrode 124, a gate insulating layer 140 disposed between the gate line 121 and the liquid crystal layer 3, a semiconductor layer 154 disposed between the gate insulating layer 140 and the liquid crystal layer 3, a data line 171 disposed between the semiconductor layer 154 and the liquid crystal layer 3 to extend in a second direction D2, a source electrode 173 connected with the data line 171, a drain electrode 175 separated from the source electrode 173, and a passivation layer 180 disposed between the data line 171 and the liquid crystal layer 3. Note that D3 is a direction perpendicular to directions D1 and D2.

The semiconductor layer 154 comprises a channel at a portion that is not covered by the source electrode 173 and the drain electrode 175. The gate electrode 124, the semiconductor layer 154, the source electrode 173, and the drain electrode 175 constitute one thin film transistor.

A pixel electrode 191 is disposed on the passivation layer 180. The pixel electrode 191 may be physically and electrically connected to the drain electrode 175 through a contact hole 185 of the passivation layer 180.

A first alignment layer 11 may be disposed between the pixel electrode 191 and the liquid crystal layer 3.

The color conversion display panel 30 includes a second substrate 310 that overlaps the thin film transistor array panel 100.

A metal oxide layer 321 is disposed between the second substrate 310 and the liquid crystal layer 3. It is described in FIG. 2 that the second substrate 310 and the metal oxide layer 321 contact each other, but the embodiments are not limited thereto. For example, a buffer layer may be disposed between the second substrate 310 and the metal oxide layer 321.

The metal oxide layer 321 may have a refractive index of about 2.3 to 3.0 in a visible light region (a wavelength of about 550 nm), and an optical absorption rate of about 0.3 to 1.0. The metal oxide layer 321 may include any material that satisfies these conditions, such as an oxide including at least one of molybdenum (Mo) and tantalum (Ta).

According to an exemplary embodiment, the metal oxide layer 321 may further include at least one of tantalum (Ta), titanium (Ti), tungsten (W), niobium (Nb), and the like. For example, when the metal oxide layer 321 includes molybdenum (Mo), it may further include tantalum (Ta). The further included element may be included in a range of about 1.0 to 10 at % of a total content of the metal oxide layer 321.

The second substrate 310 according to the present exemplary embodiment may include display areas DA for emitting red light, green light, and blue light, and a light-blocking area PA positioned between the display areas DA.

The metal oxide layer 321 may include a first metal oxide layer 321a which overlaps the light-blocking area PA, and a second metal oxide layer 321b which overlaps the display area DA. The first metal oxide layer 321a and the second metal oxide layer 321b may have shapes that are connected with or separated from each other according to an exemplary embodiment.

According to an exemplary embodiment, a thickness of the first metal oxide layer 321a may be greater than a thickness of the second metal oxide layer 321b. According to an example, the thickness of the first metal oxide layer 321a is in a range of about 300 to 700 Å, and the thickness of the second metal oxide layer 321b is in a range of about 20 to 50 Å.

The second metal oxide layer 321b may be manufactured by any process for forming it thinner than the first metal oxide layer 321a. According to an example, the second metal oxide layer 321b may be formed by forming a metal oxide layer on both the display areas DA and the light-blocking area PA to have a same thickness as that of the first metal oxide layer 321a, and then performing additional etching (halftone etching or the like) on the metal oxide layer positioned on the display area DA, but the embodiments are not limited thereto.

The metal oxide layer 321 may further include a reflective metal layer 322 disposed between the first metal oxide layer 321a and the liquid crystal layer 3. The reflective metal layer 322 overlaps the light-blocking area PA. The reflective metal layer 322 and the first metal oxide layer 321a positioned in the light-blocking area PA may serve as a light blocking member.

The reflective metal layer 322 and the first metal oxide layer 321a positioned in the light-blocking area PA may be disposed between a first color conversion layer 330R and a second color conversion layer 330G adjacent to each other, and between a transmission layer 330B and the first color conversion layer 330R, to define the first color conversion layer 330R, the second color conversion layer 330G, and the transmission layer 330B. The reflective metal layer 322 may have a lattice shape in a plan view, and is stacked adjacent to the first metal oxide layer 321a.

The reflective metal layer 322 may have any thickness that causes destructive interference of external light introduced from outside of the second substrate 310 together with the first metal oxide layer 321a. For example, the thickness of the reflective metal layer 322 may be in a range of about 1000 to 50,000 Å.

The reflective metal layer 322 may include any metal for reflecting light generated inside the color conversion display panel 30 to increase light efficiency by recycling, and may include aluminum (Al), for example.

In addition, the reflective metal layer 322 may further include at least one of nickel (Ni), lanthanum (La), neodymium (Nd), and the like according to an exemplary embodiment. Each of nickel (Ni), lanthanum (La) and neodymium (Nd) may be included in a range of about 0.01 to 0.1 at % relative to a total content.

The reflective metal layer 322 may again reflect light emitted from the first color conversion layer 330R, the second color conversion layer 330G, and the transmission layer 330B toward the color conversion layers 330R and 330G and the transmission layer 330B. The reflective metal layer 322 may improve the light efficiency by reflecting light that travels therein without being emitted outside of the second substrate 310 again to the color conversion layers 330R and 330G or the transmission layer 330B.

A capping layer 325 may be disposed between the reflective metal layer 322 and the liquid crystal layer 3, and between the liquid crystal layer 3 and the metal oxide layer 321 disposed in the display area DA. The capping layer 325 may prevent a hillock phenomenon, such as swelling of the reflective metal layer 322, and may improve adhesion with other constituent elements. According to an exemplary embodiment, the capping layer 325 may be omitted.

The capping layer 325 may include at least one of a silicon oxide, a silicon oxynitride, and a silicon nitride. The capping layer 325 may have various stacked structures such as a single-layer structure and a double-layer structure.

The capping layer 325 may have a thickness that is in a range of 300 to 4000 Å. The capping layer 325 may be formed by any manufacturing method to have the thickness described above, and may be formed by chemical vapor deposition (CVD) as an example.

According to the present exemplary embodiment, the second metal oxide layer 321b and the capping layer 325 may be disposed in the display area DA, and may partially absorb external light or cause destructive interference of it, thereby reducing external light reflection and improving color reproducibility. In addition, the first metal oxide layer 321a, the reflective metal layer 322, and the capping layer 325 may be disposed in the light-blocking area PA to absorb external light or cause destructive interference of it and to again reflect light that travels therein without being emitted outside of the second substrate 310 toward the color conversion layers 330R and 330G, thereby improving the efficiency of light outputted from the inside thereof.

A blue light cutting filter 327 is disposed between the capping layer 325 and the color conversion layers 330R and 330G. The blue light cutting filter 327 is positioned to overlap regions for emitting red and green light, and is not positioned in a region for emitting blue light.

The blue light cutting filter 327 may include a first region that overlaps the first color conversion layer 330R and a second region that overlaps the second color conversion layer 330G, and the regions may be connected to each other. However, the embodiments are not limited thereto. For example, the first region and the second region may be formed apart from each other.

The blue light cutting filter 327 may block or absorb blue light supplied from the light unit 500. The blue light introduced from the light unit 500 into the first color conversion layer 330R and the second color conversion layer 330G may be converted into red or green light by semiconductor nanocrystals 331R and 331G. In this case, some blue light may be outputted without being converted, and such blue light and the red or green light may be mixed to reduce the color reproducibility. The blue light cutting filter 327 may absorb the blue light outputted from the first color conversion layer 330R and the second color conversion layer 330G without being converted as described above to prevent red light or green light and blue light from being mixed.

The blue light cutting filter 327 may include any material for performing the above-mentioned effects, and may include a yellow color filter as an example. The blue light cutting filter 327 may have a single-layer structure or a stacked structure of a plurality of layers.

A plurality of the color conversion layers 330R and 330G may be disposed between the blue light cutting filter 327 and the liquid crystal layer 3, and the transmission layer 330B may be disposed between the second substrate 310 and the liquid crystal layer 3.

The color conversion layers 330R and 330G may serve to convert incident light into light having a different wavelength from that of the incident light and emit the converted light. The color conversion layers 330R and 330G may include the first color conversion layer 330R and the second color conversion layer 330G. In this case, the first color conversion layer 330R may be a red color conversion layer and the second color conversion layer 330G may be a green color conversion layer.

The transmission layer 330B may emit incident light without color conversion. For example, blue light may be introduced to emit blue light. In this case, the blue light can be scattered by a scatterer 335 described later to be emitted.

The first color conversion layer 330R may include the first semiconductor nanocrystal 331R that converts incident blue light into red light. The first semiconductor nanocrystal 331R may include at least one of a phosphor and a quantum dot.

The second color conversion layer 330G may include the second semiconductor nanocrystal 331G that converts incident blue light into green light. The second semiconductor nanocrystal 331G may include at least one of a phosphor and a quantum dot.

In this case, the quantum dot can be selected from a group II-VI compound, a group III-V compound, a group IV-VI compound, a group IV element, a group IV compound, and a combination thereof.

For the group II-VI compound, a binary compound selected from CdSe, CdTe, ZnS, ZnSe, ZnTe, ZnO, HgS, HgSe, HgTe, MgSe, MgS, and a mixture thereof; a ternary compound selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and a mixture thereof; or a quaternary compound selected from HgZnTeS, CdZnSeS, CdZnSeTe, CdZnSTe, CdHgSeS, CdHgSeTe, CdHgSTe, HgZnSeS, HgZnSeTe, HgZnSTe, and a mixture thereof, may be employed. For the group III-V compound, a binary compound selected from GaN, GaP, GaAs, GaSb, AlN, AlP, AlAs, AlSb, InN, InP, InAs, InSb, and a mixture thereof; a ternary compound selected from GaNP, GaNAs, GaNSb, GaPAs, GaPSb, AlNP, AINAs, AlNSb, AlPAs, AlPSb, InNP, InNAs, InNSb, InPAs, InPSb, and a mixture thereof; or a quaternary compound selected from GaAlNAs, GaAlNSb, GaAlPAs, GaAlPSb, GaInNP, GaInNAs, GaInNSb, GaInPAs, GaInPSb, GaAlNP, InAlNP, InAlNAs, InAlNSb, InAlPAs, InAlPSb, and a mixture thereof, may be employed. For the group IV-VI compound, a binary compound selected from SnS, SnSe, SnTe, PbS, PbSe, PbTe, and a mixture thereof; a ternary compound selected from SnSeS, SnSeTe, SnSTe, PbSeS, PbSeTe, PbSTe, SnPbS, SnPbSe, SnPbTe, and a mixture thereof; or a quaternary compound selected from SnPbSSe, SnPbSeTe, SnPbSTe, and a mixture thereof, may be employed. For the IV group element, Si, Ge, or a mixture thereof may be selected. For the IV group compound, a binary compound selected from SiC, SiGe, and a mixture thereof may be employed.

In this case, the binary compound, the ternary compound, or the quaternary compound may exist in a uniform concentration or in a partially different concentration in particles. The quantum dot may include multiple quantum dots, and the quantum dots may have a core/shell structure in which one quantum dot surrounds another quantum dot. An interface between a core and a shell may have a concentration gradient such that a concentration of an element in the shell decreases toward a center thereof.

The quantum dot may have a full width at half maximum (FWHM) of the light-emitting wavelength spectrum that is equal to or less than about 45 nm, suitable equal to or less than about 40 nm, and more suitable equal to or less than about 30 nm, and in this range, color purity or color reproducibility may be improved. In addition, since light emitted through the quantum dot is emitted in all directions, a viewing angle of light may be improved.

The quantum dot is not specifically limited to have shapes that are generally used in the technical field related to the present disclosure, and more specifically, may have a shape such as a nano-particle having a spherical shape, a pyramid shape, a multi-arm shape, or a cubic shape, or may be a nanotube, a nanowire, a nanofiber, a planar nano-particle, etc.

When the first semiconductor nanocrystal 331R includes a red phosphor, the red phosphor may include at least one of (Ca, Sr, Ba)S, (Ca, Sr, Ba)₂Si₅N₈, CaAlSiN₃, CaMoO₄, and Eu₂Si₅N₈, but is not limited thereto.

When the second semiconductor nanocrystal 331G includes a green phosphor, the green phosphor may include at least one of yttrium aluminum garnet (YAG), (Ca, Sr, Ba)₂SiO₄, SrGa₂S₄, barium magnesium aluminate (BAM), α-SiAlON), β-SiAlON, Ca₃Sc₂Si₃Oi₂, Tb₃Al₅O₁₂, BaSiO₄, CaAlSiON, and (Sr₁₋ₓBaₓ)Si₂O₂N₂. In this case, the x may be any number between 0 and 1.

The transmission layer 330B may include a resin that transmits blue light incident thereto. The transmission layer 330B positioned in a region for emitting blue light emits introduced blue light as it is without a separate phosphor or quantum dot.

Although not illustrated in the present specification, the transmission layer 330B may further include at least one of a dye and a pigment according to an exemplary embodiment. The transmission layer 330B including the dye and the pigment may supply blue light with improved color purity while reducing external light reflection.

The first color conversion layer 330R, the second color conversion layer 330G, and the transmission layer 330B may include a photosensitive resin as an example, and may be manufactured by a photolithography process. Alternatively, the first color conversion layer 330R, the second color conversion layer 330G, and the transmission layer 330B may be manufactured by a printing process, and when manufactured by the printing process, they may include materials other than the photosensitive resin. In the present specification, it is illustrated that the color conversion layer, the transmissive layer, and the light blocking layer are formed by the photolithography process or the printing process, but the present disclosure is not limited thereto.

At least one of the first color conversion layer 330R, the second color conversion layer 330G, and the transmission layer 330B may further include the scatterers 335. As an example, each of the first color conversion layer 330R, the second color conversion layer 330G, and the transmission layer 330B may have the scatterers 335, or the transmission layer 330B may include the scatterers 335, and the first color conversion layer 330R and the second color conversion layer 330G may not include the scatterers 335. Various other exemplary embodiments may be possible. A content of the scatterers 335 included in each of the first color conversion layer 330R, the second color conversion layer 330G, and the transmission layer 330B may be different.

The scatterers 335 may include any material for uniformly scattering incident light. The scatterers 335 may include at least one of TiO₂, ZrO₂, Al₂O₃, In₂O₃, ZnO, SnO₂, Sb₂O₃, and ITO, for example.

An optical filter layer 340 may be disposed between the color conversion layers 330R and 330G and the liquid crystal layer 3, and may be disposed between the transmission layer 330B and the liquid crystal layer 3. The optical filter layer 340 may overlap a front surface of the second substrate 310, and the optical filter layer 340 may be omitted depending on an exemplary embodiment.

The optical filter layer 340 may serve to prevent damage and extinction of the semiconductor nanocrystals 331R and 331G included in the first color conversion layer 330R and the second color conversion layer 330G in high-temperature processes after the first color conversion layer 330R, the second color conversion layer 330G, and the transmission layer 330B are formed.

The optical filter layer 340 may serve as a filter that reflects or absorbs light other than light having a specific wavelength while transmitting the light having the specific wavelength. The optical filter layer 340 may have a structure in which a layer having a high refractive index and a layer having a low refractive index are alternately stacked to form about 10 to 20 layers. That is, the optical filter layer 340 may have a structure in which a plurality of layers having different refractive indexes are stacked. To that end, the optical filter layer utilizes a principle of transmitting and/or reflecting light having a specific wavelength using reinforcement and/or destructive interference between an inorganic layer having a high refractive index and an inorganic layer having a low refractive index.

The optical filter layer 340 may include at least one of TiO₂, SiNₓ, SiO_{y}, TiN, AlN, Al₂O₃, SnO₂, WO₃, and ZrO₂. For example, it may have a structure in which SiNₓ, and SiO_{y} are alternately stacked. In SiNₓ, SiO_{y}, x and y determine a chemical composition ratio, and can be controlled depending on process conditions for forming a layer.

An overcoat layer 350 may be disposed between the optical filter layer 340 and the liquid crystal layer 3. The overcoat layer 350 may overlap a front surface of the second substrate 310.

The overcoat layer 350 may serve to planarize one surface of the first color conversion layer 330R, the second color conversion layer 330G, and the transmission layer 330B. The overcoat layer 350 may include an organic material, but is not limited thereto, and any material capable of performing a planarization function is possible.

A second polarization layer 22 may be disposed between the overcoat layer 350 and the liquid crystal layer 3. For the second polarization layer 22, one or more of an applied polarization layer, a coated polarization layer, and a wire grid polarizer may be used. As one example, the second polarization layer 22 may be a metal pattern wire grid polarizer. The second polarization layer 22 may be positioned between the overcoat layer 350 and the liquid crystal layer 3 in various forms such as a film form, a coating form, an attachment form, a printing form, and the like. When the second polarization layer 22 is the wire grid polarizer, it may include a plurality of bars of the second polarization layer 22 having a width of several nanometers.

Next, an insulating layer 362, a common electrode 370, and a second alignment layer 21 may be sequentially disposed between the second polarization layer 22 and the liquid crystal layer 3.

The insulating layer 362 serves to insulate the second polarization layer 22 made of a metal material from the common electrode 370, and may be omitted when the second polarization layer 22 is not made of a metal material. The common electrode 370 receiving a common voltage may generate an electric field together with the aforementioned pixel electrode 191.

The liquid crystal layer 3 is disposed between the thin film transistor array panel 100 and the color conversion display panel 30 to have a plurality of liquid crystal molecules 31, and movement of the liquid crystal molecules 31 is controlled by an electric field generated between the pixel electrode 191 and the common electrode 370. Images may be displayed by controlling transmittance of light received from the light unit 500 depending on a movement degree of the liquid crystal molecules 31.

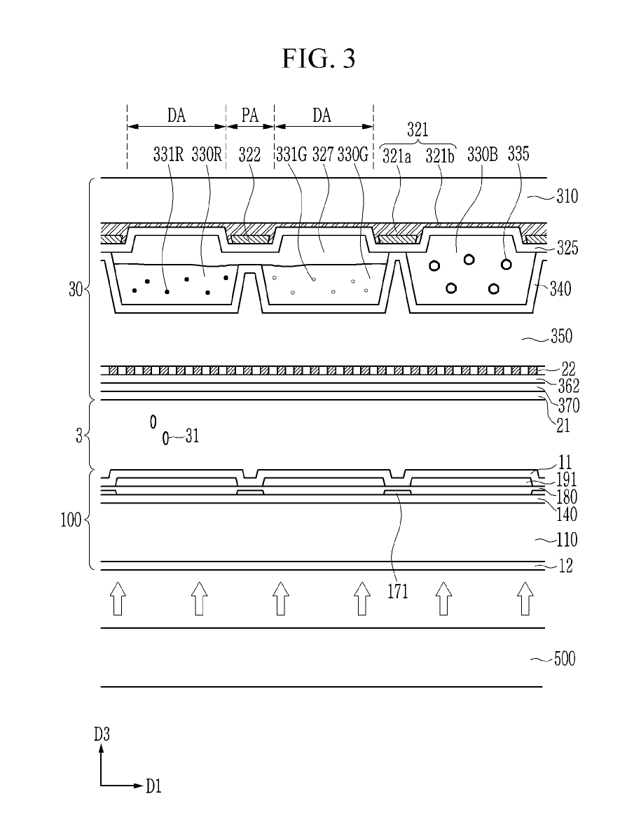

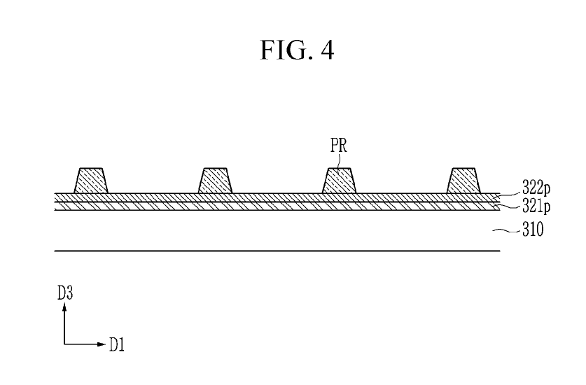

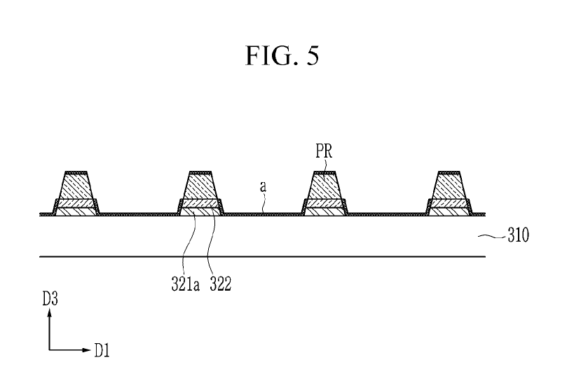

Hereinafter, a display device according to a modification will be described with reference to FIG. 3 to FIG. 5. FIG. 3 is a cross-sectional view according to a modification of FIG. 2, and FIG. 4 and FIG. 5 are respectively cross-sectional views of a process of manufacturing a color conversion display panel of FIG. 3. Description related to constituent elements that are identical or similar to the constituent elements described with reference to FIG. 1 and FIG. 2 will be omitted.

First, referring to FIG. 3, a metal oxide layer 321 is disposed between the second substrate 310 and the liquid crystal layer 3. In this specification, the exemplary embodiment in which the second substrate 310 contacts the metal oxide layer 321 is illustrated, but it is not limited thereto. For example, a buffer layer may be disposed between the second substrate 310 and the metal oxide layer 321.

According to the present exemplary embodiment, the second substrate 310 may include display areas DA for emitting red light, green light, and blue light, and a light-blocking area PA positioned between the display areas DA.

The metal oxide layer 321 may include a first metal oxide layer 321a which overlaps the light-blocking area PA, and a second metal oxide layer 321b which overlaps the display area DA. The first metal oxide layer 321a and the second metal oxide layer 321b may have shapes that are connected with or separated from each other according to an exemplary embodiment.

The first metal oxide layer 321a may cover a side surface of the reflective metal layer 322 to be described later according to an exemplary embodiment. In addition, a thickness of the first metal oxide layer 321a may be greater than a thickness of the second metal oxide layer 321b.

The second metal oxide layer 321b may be formed by any process for forming a thinner layer than the first metal oxide layer 321a. As one example, the second metal oxide layer 321b may be manufactured through a same process as in the exemplary embodiment of FIG. 4 and FIG. 5.

Specifically, a layer 321p including a metal oxide and a layer 322p including a reflective metal are sequentially disposed on the second substrate 310. Next, as shown in FIG. 3, a photoresist pattern PR may be formed to serve as partitions between the first color conversion layer 330R and the second color conversion layer 330G, between the second color conversion layer 330G and the transmission layer 330B, and between the transmission layer 330B and the first color conversion layer 330R, which are adjacently positioned.

Next, as shown in FIG. 5, the layer 321p including the metal oxide and the layer 322p including the reflective metal are etched by using the photoresist pattern PR as a mask to form the reflective metal layer 322 and the first metal oxide layer 321a. Thereafter, a metal oxide “a” is disposed on a top surface of the second substrate 310. A side surface of the photoresist pattern PR may not be covered by the metal oxide a in a disposing operation of the metal oxide a. The metal oxide a may be made of a same material as the first metal oxide layer 321a.

Next, when the photoresist pattern PR is removed, the metal oxide a formed on the photoresist pattern PR is removed, and the metal oxide a formed on the surface of the second substrate 310 and the side surface of the reflective metal layer 322 and the first metal oxide layer 321a remains. When the metal oxide a is made of the same material as the first metal oxide layer 321a, the metal oxide a may be connected to the first metal oxide layer 321a.

According to this manufacturing process, as shown in FIG. 3, the second metal oxide layer 321b having a thickness that is thinner than a thickness of the first metal oxide layer 321a may be formed.

The other constituent elements are the same as the constituent elements described with reference to FIG. 1 and FIG. 2, and thus will be omitted in the following description.

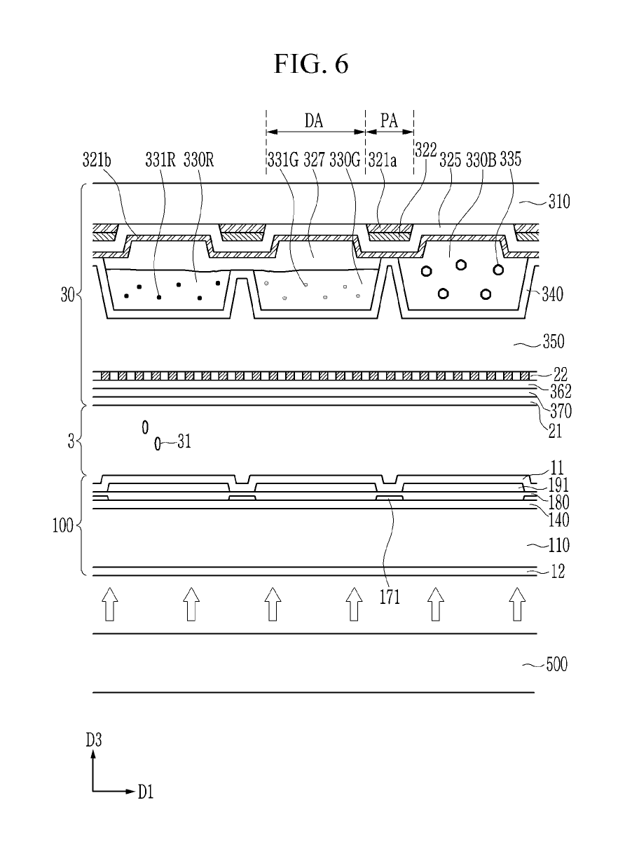

Hereinafter, a display device according to another exemplary embodiment will be described with reference to FIG. 6. FIG. 6 is a cross-sectional view according to a modification of FIG. 2.

In the display device illustrated in FIG. 6, the first metal oxide layer 321a and the reflective metal layer 322 are disposed to overlap the light-blocking area PA of the second substrate 310. The first metal oxide layer 321a and the reflective metal layer 322 may have a double-layer structure, and may serve as a light blocking member.

The first metal oxide layer 321a and the reflective metal layer 322 may be disposed between the first color conversion layer 330R and the second color conversion layer 330G, between the second color conversion layer 330G and the transmission layer 330B, and between the transmission layer 330B and the first color conversion layer 330R.

The capping layer 325 may be disposed between the second substrate 310 and the liquid crystal layer 3, and between the reflective metal layer 322 and the liquid crystal layer 3. The capping layer 325 may prevent a hillock phenomenon which may occur in the reflective metal layer, and may improve adhesion with other constituent elements.

The second metal oxide layer 321b may be disposed between the capping layer 325 and the liquid crystal layer 3. The second metal oxide layer 321b may overlap a top surface of the second substrate 310, and may include a material that is identical or similar to that of the first metal oxide layer 321a.

The second metal oxide layer 321b may be formed by using any forming process, e.g., a sputtering method, according to an exemplary embodiment.

The second metal oxide layer 321b and the capping layer 325 may be disposed in the display area DA, to partially absorb external light or cause destructive interference of it, thereby reducing external light reflection. In addition, the first metal oxide layer 321a, the reflective metal layer 322, and the capping layer 325 may be disposed in the light-blocking area PA to absorb external light or cause destructive interference of it and to again reflect light that travels therein without being emitted outside of the second substrate 310 again toward the color conversion layers 330R and 330G through the reflective metal layer 322, thereby improving the efficiency of light outputted from the inside thereof.

Hereinafter, reflectivity of external light and internal light according to comparative examples and examples will be described.

TABLE 1

| | | | Reflectivity | |
|---|---|---|---|---|
| | | | External | Internal |
| | Area | Structure | light (%) | light (%) |
| Examples | Light- | MoTaOx/Al alloy | 5 | 91 |
| | blocking area | | | |
| | Display area | Glass/SiOx/ | 8 | — |
| | | MoTaOx/ | | |
| | | organic layer | | |
| | | Glass/MoTaOx/ | 7 | — |
| | | SiOx/organic | | |
| | | layer | | |
| Comparative | Light- | ITO/Ag/ITO | 95 | 95 |
| Examples | blocking area | Ti/Cu | 37 | 63 |
| | Display area | Glass/organic | 9 | — |
| | | layer | | |
| | | Glass/SiNx/ | 14 | — |
| | | organic layer | | |

First, in the light-blocking area, the example in which the light-blocking area has a metal oxide layer (MoTaOx) and a reflective metal layer (Al alloy) has external light reflection of about 5% and internal light reflection of about 91%. For comparison, a first comparative example in which the light-blocking area has an ITO/Ag/ITO stacked structure has the external light reflection of about 95% and the internal light reflection of about 95%, and a second comparative example in which the light-blocking area has a Ti/Cu stacked structure has the external light reflection of about 37% and the internal light reflection of about 63%. As a result, according to the examples, the internal light reflection may reach about 91% while the external light reflection reaches the smallest level.

The display area is required to have low external light reflectance. As the external light reflectance increases, a distortion level of the color visible to user eyes increases. Referring to Table 1, according to the examples, the external light reflectance is in a range of 7 to 8%. According to the comparative examples, the external light reflectance is in a range of 9 to 14%.

As a result, the examples may have low external light reflectance in the display area requiring the low external light reflectance as compared with the comparative examples, and may have high internal light reflectance in the light-blocking area, thereby providing high light efficiency.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

### DESCRIPTION OF SYMBOLS

321a: first metal oxide layer
321b: second metal oxide layer
322: reflective metal layer
325: capping layer

What is claimed is:

1. A color conversion display panel comprising:
a substrate including a display area and a light-blocking area;
a metal oxide layer disposed on the substrate to overlap the display area and the light-blocking area;
a reflective metal layer disposed on the metal oxide layer to overlap the light-blocking area;
a color conversion layer disposed on the metal oxide layer which overlaps the display area to include semiconductor nanocrystals; and
a transmission layer disposed on the metal oxide layer which overlaps the display area.

2. The color conversion display panel of claim 1, wherein the metal oxide layer includes:
a first metal oxide layer overlapping the light-blocking area; and
a second metal oxide layer overlapping the display area,
wherein a thickness of the first metal oxide layer is different from a thickness of the second metal oxide layer.

3. The color conversion display panel of claim 2, wherein the thickness of the first metal oxide layer is greater than the thickness of the second metal oxide layer.

4. The color conversion display panel of claim 2, wherein the thickness of the first metal oxide layer is in a range of about 300 to 700 Å, and the thickness of the second metal oxide layer is in a range of about 20 to 50 Å.

5. The color conversion display panel of claim 2, wherein the reflective metal layer overlaps the first metal oxide layer.

6. The color conversion display panel of claim 1, wherein the metal oxide layer includes an oxide including at least one of molybdenum (Mo) and tantalum (Ta).

7. The color conversion display panel of claim 6, wherein the metal oxide layer further includes at least one of tantalum (Ta), titanium (Ti), tungsten (W), niobium (Nb).

8. The color conversion display panel of claim 1, wherein the reflective metal layer includes aluminum (Al).

9. The color conversion display panel of claim 8, wherein the reflective metal layer further includes at least one of nickel (Ni), lanthanum (La), neodymium (Nd).

10. The color conversion display panel of claim 1, wherein the metal oxide layer contacts a side surface of the reflective metal layer.

11. The color conversion display panel of claim 2, further comprising a capping layer disposed between the reflective metal layer and the color conversion layer, and between the reflective metal layer and the transmission layer.

12. The color conversion display panel of claim 11, wherein the second metal oxide layer is disposed between the capping layer and the color conversion layer, and between the capping layer and the transmission layer.

13. A display device comprising:
a thin film transistor array panel; and
a color conversion display panel facing the thin film transistor array panel,
wherein the color conversion display panel includes:
a substrate including a display area and a light-blocking area;
a metal oxide layer disposed on the substrate to overlap the display area and the light-blocking area;
a reflective metal layer disposed on the metal oxide layer to overlap the light-blocking area;
a color conversion layer disposed on the metal oxide layer which overlaps the display area to include semiconductor nanocrystals; and
a transmission layer disposed on the metal oxide layer which overlaps the display area.

14. The display device of claim 13, wherein the metal oxide layer includes:
a first metal oxide layer overlapping the light-blocking area; and
a second metal oxide layer overlapping the display area,
wherein a thickness of the first metal oxide layer is different from a thickness of the second metal oxide layer.

15. The display device of claim 14, wherein the thickness of the first metal oxide layer is in a range of about 300 to 700 Å, and the thickness of the second metal oxide layer is in a range of about 20 to 50 Å.

16. The display device of claim 13, wherein the reflective metal layer overlaps the first metal oxide layer.

17. The display device of claim 14, wherein the second metal oxide layer is disposed between the capping layer and the color conversion layer, and between the capping layer and the transmission layer.

18. A display device comprising:
a thin film transistor array panel; and
a color conversion display panel facing the thin film transistor array panel,
wherein the color conversion display panel includes:
a substrate including a display area and a light-blocking area;
a metal oxide layer overlapping the display area and the light-blocking area;
a reflective metal layer overlapping the light-blocking area;
a color conversion layer disposed on the metal oxide layer which overlaps the display area to include semiconductor nanocrystals; and
a transmission layer disposed on the metal oxide layer which overlaps the display area.

19. The display device of claim 18, wherein the metal oxide layer includes:
a first metal oxide layer overlapping the light-blocking area; and
a second metal oxide layer overlapping the display area,
wherein a thickness of the first metal oxide layer is different from a thickness of the second metal oxide layer.

20. The display device of claim 18, wherein the reflective metal layer overlaps the first metal oxide layer.
